(19) United States
(12) Patent Application Publication
(10) Pub. No.: US 2009/0037845 A1
(43) Pub. Date: Feb. 5, 2009

(54) Method and System for Editing Web Data

(76) Inventor: Tzu-Han Kao, Sinjhuang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/936,200

(22) Filed: Nov. 7, 2007

(30) Foreign Application Priority Data
Aug. 3, 2007 (TW) 096128776

(51) Int. Cl. G06F 3/048

(52) U.S. Cl. 715/823

(57) ABSTRACT

The method for editing web data of the invention is applied to a web-editing system. The system receives a plurality of information via an internet. A user can use the system to edit the plurality of information. The method for editing web data comprises the following steps: displaying the plurality of information, a web-editing interface and a cursor, and when the cursor moves to one of the plurality of information, the one of the plurality of information appears with a selected effect; extracting the one of the plurality of information and showing on the web-editing interface when the user selects the one of the plurality of information; setting at least one parameter of the one of the plurality of information shown on the web-editing interface as editing information and displaying the editing information on the web-editing interface; converting the editing information to target editing information readable by an electronic device; and transferring the target editing information to the electronic device.

### BACKGROUND OF THE INVENTION

1. Field of the Invention

The present invention relates to a method and system for editing web data, and, more particularly, to a method and system for editing internet information and transmitting the information to various electronic devices.

2. Description of the Related Art

In the prior art web data editing technology, a user utilizes web data editing software (such as FrontPage, Dreamweaver, etc.) for editing purposes, which requires related operation and design knowledge. However, not every user is capable of operating the web data editing software. Also, during editing, each webpage needs to be created from scratch, which may take a lot of time.

Another prior art web editing technology provides a personalized webpage, which is easier to operate. A system service provider provides many different types of material or information (such as calendars, weather, layout, news, etc.) so the user can select among them. However, the content of this type of personalized webpage is limited, and the user cannot use other types of information on the internet for editing purposes.

Another prior art web editing technology provides a method to directly extract information from the internet; however, it is limited to textual and image information and the edited webpage cannot be transmitted and displayed on various types of electronic devices (such as PDAs, mobile phones, etc.).

Therefore, it is desirable to provide a system and method for editing web data to mitigate and/or obviate the aforementioned problems.

### SUMMARY OF THE INVENTION

A main objective of the present invention is to provide a method for editing web data, which can edit internet information and send the edited information to various electronic devices.

Another objective of the present invention is to provide a web-editing system, which can edit internet information and send the edited information to various electronic devices.

In order to achieve the above mentioned objectives, the method of the present invention is applied to a web-editing system. The system receives a plurality of information via an internet, and the user can use the system to edit the plurality of information. The method for editing web data comprises: displaying the plurality of information, a web-editing interface and a cursor, and when the cursor moves to one of the plurality of information, the one of the plurality of information appears with a selected effect; extracting the one of the plurality of information for showing on the web-editing interface when the user selects the one of the plurality of information; setting at least one parameter of the one of the plurality of information shown on the web-editing interface as editing information and displaying the editing information on the web-editing interface; converting the editing information to target editing information readable by the electronic device; and transmitting the target editing information to the electronic device.

In order to achieve another objective, the web-editing system of the present invention receives a plurality of information via an internet, and the user can use the system to edit the plurality of information and send the edited result to the electronic device. The web-editing system comprises a display module, an extraction module, an editing module, a compiling module, an information transmission module. The display module is used for displaying the plurality of information, a web-editing interface and a cursor, and when the cursor moves to one of the plurality of information, the one of the plurality of information is shown with a selected effect. The extraction module is used for extracting the one of the plurality of information for showing on the web-editing interface when the user selects the one of the plurality of information. The editing module is used for setting the one of the plurality of information displayed on the web-editing interface as at least one parameter to become editing information and displaying the editing information on the web-editing interface. The compiling module is used for converting the editing information to target editing information readable by the electronic device. The information transmission module is used for transmitting the target editing information to the electronic device.

Other objects, advantages, and novel features of the invention will become more apparent from the following detailed description when taken in conjunction with the accompanying drawings.

### BRIEF DESCRIPTION OF THE DRAWINGS

FIG. 1 is a structural drawing of a web-editing system according to the present invention.

FIG. 2 is a flow chart of a web-editing method.

FIG. 3 to FIG. 5 are embodiments shown on a screen of a user computer according to the present invention.

FIG. 6 is an embodiment shown on a screen of an electronic device.

### DETAILED DESCRIPTION OF THE PREFERRED EMBODIMENT

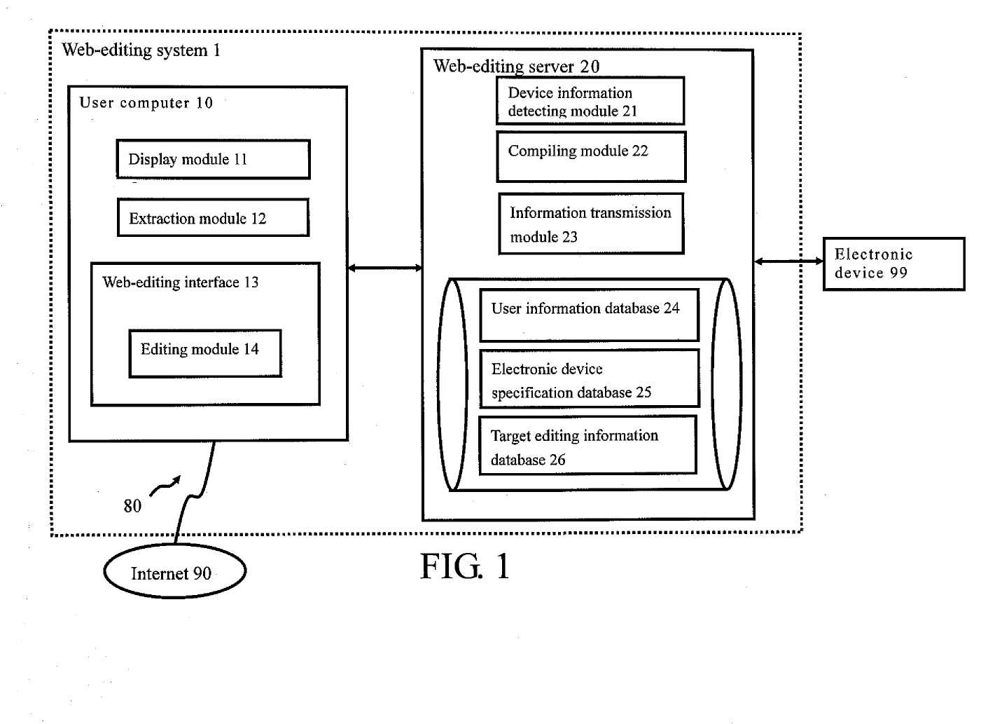

Please refer to FIG. 1. FIG. 1 is a structural drawing of a web-editing system according to the present invention. A web-editing system 1 receives a plurality of information 80 via an internet 90, and the user can edit the plurality of information 80 with the web-editing system 1 and send edited result to an electronic device 99.

The plurality of information 80 can be different types of information having various formats transmitted by the internet 90, such as text information, static graphical information, dynamic image information, audio information, multimedia information, etc. The electronic device 99 has a screen and is capable of transmitting information; for example, the electronic device 99 may be a portable electronic device (such as a mobile phone, a PDA or a notebook computer, etc.) or a non-portable device (such as a desktop computer). The web-editing system 1 comprises a user computer 10 and a web-editing server 20, and the user computer 10 and the web-editing server 20 are electrically connected together; for example, the user computer 10 and the web-editing server 20 can be electrically connected via the internet 90 to facilitate the transmission of information.

The user computer 10 comprises a display module 11, an extraction module 12 and a web-editing interface 13. The web-editing interface 13 further comprises an editing module 14. In this embodiment, the display module 11, the extraction module 12 and the editing module 14 are all software programs, however, the present invention can have other various designs.

The web-editing server 20 provides a web-editing service, which comprises a device information detecting module 21, a compiling module 22, an information transmission module 23, a user information database 24, an electronic device specification database 25 and a target editing information database 26. The device information detecting module 21, the compiling module 22 and the information transmission module 23 may all be software programs; however, the present invention can support other various designs.

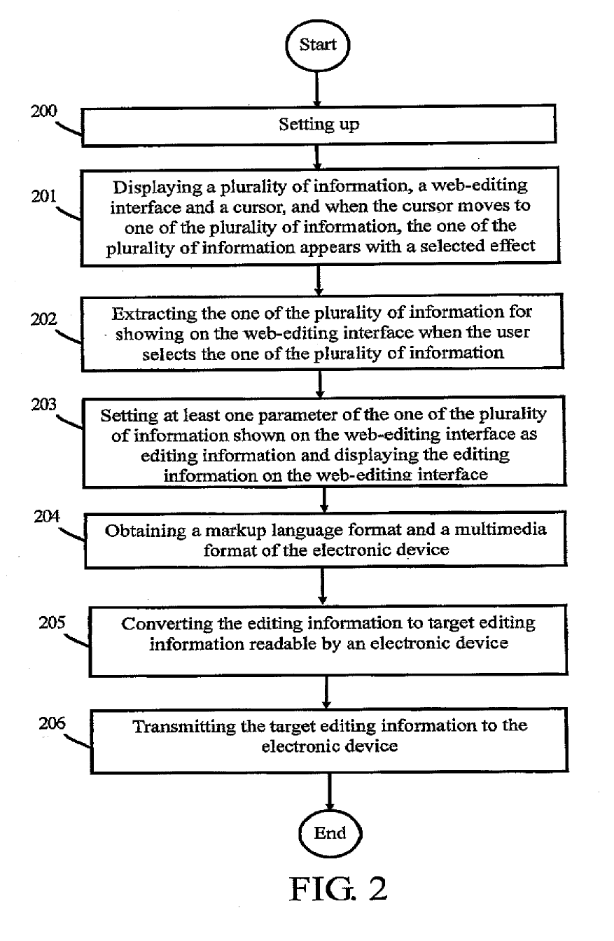

Please refer to both FIG. 1 and FIG. 2. FIG. 2 is a flow chart of a web-editing method. The following description explains the operation of the web-editing system 1 of the present invention:

### Step 200: Setting Up

When the user computer 10 first logs into the web-editing server 20, user data may be input to establish a user account, and this user data may be stored in the user information database 24. When the user computer 10 is connected to the web-editing server 20, it may log into the web-editing server 20 to recognize the user computer 10. Subsequently, the device information detecting module 21, the compiling module 22 and the information transmission module 23 of the web-editing server 20 are executed, and the user information database 24, the electronic device specification database 25 and the target editing information database 26 are accessible, to provide a customized service.

When the user computer 10 and the web-editing server 20 are connected, the user computer 10 can log into the web-editing server 20 at any time.

Step 201: Displaying the Plurality of Information, the Web-Editing Interface and a Cursor. When the Cursor is Moved to one of the Plurality of Information, the One of the Plurality of Information is Shown with a Selected Effect

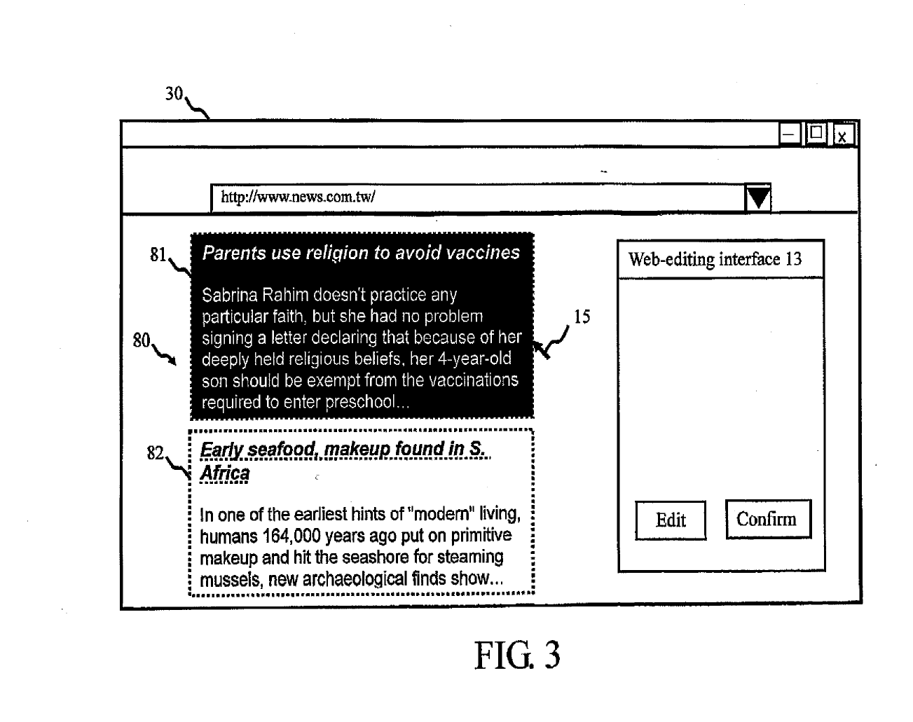

Please refer to FIG. 3. FIG. 3 is an embodiment of a picture shown on the screen. The user computer 10 executes the display module 11 to display a picture 30 on the screen of the user computer 10. The picture 30 comprises the plurality of information 80, the web-editing interface 13 and the cursor 15. The plurality of information 80 can be any information transmittable via the internet 90. The web-editing interface 13 is an external program of a web browser, which allows the user to edit the plurality of information 80 on the user computer 10.

The user computer 10 comprises an indicator (i.e. a mouse), which can control the position of the cursor 15. When the user moves the cursor 15 to one of the plurality of information 80, the one of the plurality of information may be shown with a selected effect to differentiate such selected information. For example, the effect may be a background-coloring effect or a high-lighting effect which changes the background color or text color to differentiate selected information from non-selected information. In this embodiment, the plurality of information 80 is text information. When the cursor 15 is moved to the text information 81, the background color of the area containing the text information 81 is high-lighted, and the non-selected text information 82 stays in the original state.

### Step 202: When the User Selects the One of the Plurality of Information, the One of the Plurality of Information is Extracted and Displayed on the Web-Editing Interface

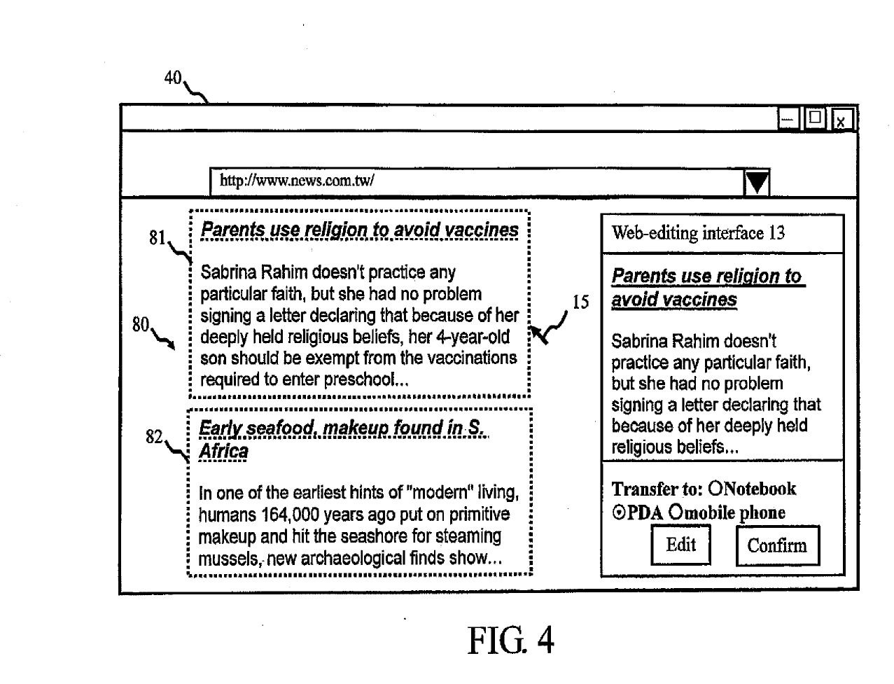

Please refer to FIG. 4. FIG. 4 shows embodiment of the displaying screen of the user computer. When the user has selected the one of the plurality of information, the user can use the indicator to select or drag the selected information. The extraction module 12 extracts a corresponding markup language section of the one of the plurality of information selected by the user, stores the markup language in the user computer 10 of the web-editing system 1, and displays the one of the plurality of information on the web-editing interface 13. The markup language corresponding to the one of the plurality of information selected by the user can also be stored in the web-editing server 20.

In this embodiment, the user has selected text information 81; the text information 81 is displayed on the web-editing interface 13, and text information 81 displayed on the web-editing interface 13 can be edited by the user.

### Step 203: Setting the One of the Plurality of Information Displayed on the Web-Editing Interface as at Least One Parameter to Become Editing Information and Displaying the Editing Information on the Web-Editing Interface

The at least one parameter can be any of various parameters in the markup language and the multimedia, which can change the characteristics of the information. For example, the parameters can be text font, size, and color parameters, background pattern parameters, displaying size parameters, resolution parameters, and image compression parameters.

When the edited information is transmitted to the electronic device 99, since different devices have different screen sizes, a “displaying size parameter” is used for adjusting to the different screen sizes of the electronic devices 99; for example, when the electronic device 99 is a notebook computer, the web-editing interface 13 may need to be enlarged; if the electronic device 99 is a mobile phone, the web-editing interface 13 may need to be reduced.

The user can also adjust the “displaying size parameter” in various ways. For example, the web-editing interface 13 can provide a selection or input region to enable the user to decide upon a preferred “displaying size parameter”. For example, when the user selects or inputs a resolution “640×480”, the web-editing interface 13 is larger; and when the user selects or inputs a resolution “320×160”, the web-editing interface 13 is smaller. The web-editing interface 13 can also be designed to be controllable by way of the mouse; that is, the user may adjust the frame size of the web-editing interface 13 using the mouse.

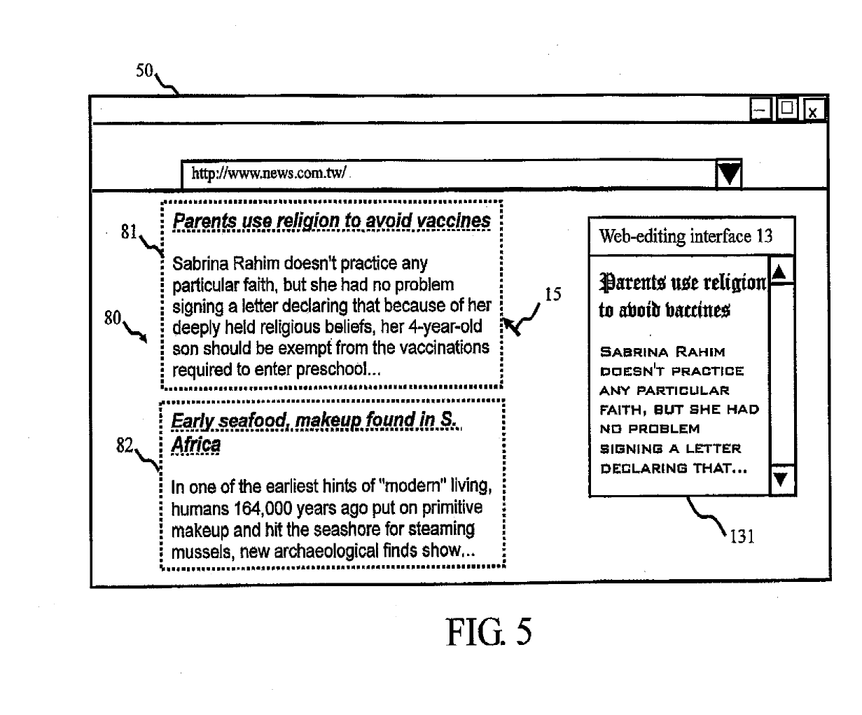

When the “displaying size parameter” is changed, the text content of the one of the plurality of information is rearranged based on the screen width of the electronic device 99, which means the word count of each line fits the screen width of the electronic device 99. Please compare the web-editing interface 13 shown in FIG. 4 and FIG. 5. The web-editing interface 13 shown in FIG. 4 is changed into the web-editing interface 13 shown in FIG. 5 by appropriate setting of the font parameters and display size parameters. In this embodiment, the size of the web-editing interface 13 shown in FIG. 5 is the screen size of one type of PDA.

The information obtained from the internet 90 can include not just text information but also other various multimedia information types. When the information to be extracted is a static graphical image, the parameters include graphic file format, resolution parameters, etc. For example, a graphic file in the jpg format can be converted into a graphic file in the gif format. When the information to be extracted is a dynamic image, the parameters include image compression parameters, coding parameters, etc.

After adjusting the parameters, the editing information 131 is immediately displayed on the web-editing interface 13, and the picture is that of the actual picture transmitted to the screen of the electronic device 99. Therefore, the web-editing interface 13 has a preview functionality.

In this embodiment, step 201 to step 203 are performed on the user computer 10, and the step to login to the web-editing server 20 can be performed after step 203. Also, the editing information 131 is transmitted from the user computer 10 to the web-editing server 20 for further editing process.

Moreover, step 201 to step 203 may be partially or completely performed in the web-editing server 20.

### Step 204: Obtaining the Markup Language Format and the Multimedia Format of the Electronic Device Via a Device Information Detecting Module

When the electronic device 99 and the web-editing server 20 are electrically connected together, the device information detecting module 21 of the web-editing server 20 has the ability to automatically detect the electronic device 99 to obtain the markup language format (such as the HTML format, WML format, etc.) and the multimedia format (such as 3gp format, MPEG4 format, etc.) used by the electronic device 99. Furthermore, the device information detecting module 21 can also detect other characteristics of the electronic device 99, such as screen displaying format (size, resolution, etc.), module type and processor type.

The device information detecting module 21 compares the detected data with the electronic device specification database 25 to obtain complete information of the electronic device 99. The electronic device specification database 25 stores complete specification characteristic information of various typical electronic devices 99.

In addition to the automatic detection performed by the web-editing server 20, the web-editing interface 13 can also be designed to be able to accept the specification information (such as module type) of the electronic device 99 input by the user or provided by some other option. Since the device information detecting module 21 can obtain the specification information of the electronic device 99, when the device information detecting module 21 detects the “displaying size parameter” set by step 203, the user does not need to input this parameter.

The specification information of the electronic device 99 and the user preferences are stored in the user information database 24. For example, the user information database 24 may store previously selected specification information of the electronic device 99.

### Step 205: Converting the Editing Information to Target Editing Information Readable by the Electronic Device

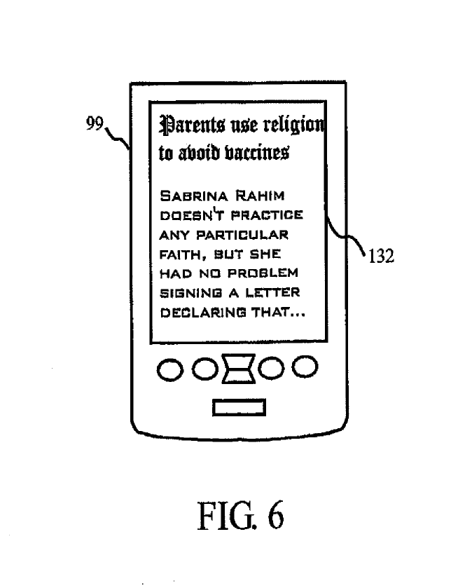

Various types of web information have many different format types, whereas each electronic device 99 usually can only read some information format types. For example, the electronic device 99 that recognizes the html format might not be able to recognize the internet information of the WML format. Therefore, a compiling module 22 of the web-editing server 20 converts the editing information 131 to target editing information 132 readable by the electronic device 99 (as shown in FIG. 6).

The compiling module 22 comprises a markup language compiling unit and a multimedia compiling unit which are respectively used for compiling information in the markup language format and multimedia format. The markup language compiling unit and the multimedia compiling unit are determined based upon the electronic device 99 of the user. For example, when the information format of the electronic device 99 includes WML, XHTML, XHTML MP, CHTML, etc. markup language formats, or JPG, GIF, BMP, TIF, WBMP, etc. static image multimedia information, or 3gp, MPEG4, WMV, SWF, etc. dynamic image multimedia information, the compiled target editing information 132 will have corresponding formats.

The converted target editing information 132 is stored in the target editing information database 26. Even if the user computer 10 is shut down, the user can still use another computer via the internet to read or edit previously-edited target editing information 132. Based upon permissions provided by the user, the target editing information 132 stored in the target editing information database 26 can also be shared, used or edited by others throughout the internet. The target editing information 132 can be a single web-page type or a website type having multiple web pages.

When the editing information is to be sent to an electronic device (such as a notebook computer) having the same markup language format, the editing information 131 is identical to the target editing information 132.

### Step 206: Transmitting the Target Editing Information to the Electronic Device

Please refer to FIG. 6. FIG. 6 is an embodiment shown on a screen of an electronic device. With the information transmission module 23, the target editing information 132 is transmitted to and displayed on the electronic device 99. In this embodiment, the electronic device 99 is a PDA, and the target editing information 132 is text information.

In this embodiment, step 204 to step 206 are performed on the web-editing server 20. Furthermore, step 204 to step 206 may be partially or completely performed on the user computer 10.

With the web-editing method of the present invention, the user can easily extract information through the internet, set corresponding parameters, and transmit to and display the information on the electronic device 99; wherein the displayed picture fits the screen size of the electronic device 99.

Although the present invention has been explained in relation to its preferred embodiment, it is to be understood that many other possible modifications and variations can be made without departing from the spirit and scope of the invention as hereinafter claimed.

What is claimed is:

1. A method for editing web data applied to a web-editing system, the system receiving a plurality of information via an internet, the system adapted to permit a user to edit the plurality of information and send edited result to an electronic device, the method comprising:
(A) displaying the plurality of information, a web-editing interface and a cursor, and when the cursor moves to one of the plurality of information, the one of the plurality of information appears with a selected effect;
(B) extracting the one of the plurality of information and showing on the web-editing interface when the user selects the one of the plurality of information;
(C) setting at least one parameter of the one of the plurality of information shown on the web-editing interface as editing information and displaying the editing information on the web-editing interface;
(D) converting the editing information to target editing information readable by the electronic device; and
(E) transmitting the target editing information to the electronic device.

2. The method as claimed in claim 1, wherein the web-editing system comprises a user computer and a web-editing server; step (A) to step (C) are performed on the user computer, and step (D) and step (E) are performed on the web-editing server.

3. The method as claimed in claim 1 further comprising:
(F) obtaining a markup language format and a multimedia format of the electronic device.

4. The method as claimed in claim 1, wherein the parameter is a displaying size parameter.

5. The method as claimed in claim 1, when the extracted information is a static image, the parameter is a resolution parameter; when the extracted information is dynamic image, the parameter is an image compression parameter.

6. The method as claimed in claim 1, wherein the selected effect is a background-coloring effect or a high-lighting effect.

7. The method as claimed in claim 1, wherein the user computer further comprises an indicator, and the indicator can control the position of the cursor; in step (B), the user operates the indicator to select or drag the one of the plurality of information.

8. The method as claimed in claim 1, wherein the one of the plurality of information is text information, static image information, dynamic image information, audio information or multimedia information.

9. The method as claimed in claim 1, wherein the electronic device is a portable electronic device.

10. A web-editing system, the system receiving a plurality of information via an internet, a user using the system to edit the plurality of information and send the edited result to an electronic device, the web-editing system comprising:
a display module, for displaying the plurality of information, a web-editing interface and a cursor, and when the cursor moves to one of the plurality of information, the one of the plurality of information is shown with a selected effect;
an extraction module, and when the user selects the one of the plurality of information, the one of the plurality of information is extracted and displayed on the web-editing interface;
an editing module for setting the one of the plurality of information displayed on the web-editing interface as at least one parameter to become editing information and displaying the editing information on the web-editing interface;
a compiling module for converting the editing information to target editing information readable by the electronic device; and
an information transmission module for transmitting the target editing information to the electronic device.

11. The web-editing system as claimed in claim 10 further comprising:
a device information detecting module for obtaining a markup language format and a multimedia format of the electronic device.

12. The web-editing system as claimed in claim 10, wherein the compiling module comprises a markup language compiling unit and a multimedia compiling unit.

13. The web-editing system as claimed in claim 10 further comprising a target editing information database for storing the target editing information.

14. The web-editing system as claimed in claim 10, wherein the parameter is a displaying size parameter.

15. The web-editing system as claimed in claim 10, when the extracted information is a static image, the parameter is a resolution parameter; when the extracted information is a dynamic image, the parameter is an image compression parameter.

16. The web-editing system as claimed in claim 10, wherein the selected effect is a background-coloring effect or a high-lighting effect.

17. The web-editing system as claimed in claim 10, wherein the user computer further comprises an indicator, and the indicator can control the position of the cursor; the user can operate the indicator to select or drag the one of the plurality of information.

18. The web-editing system as claimed in claim 10, wherein the one of the plurality of information is text information, static image information, dynamic image information, audio information or multimedia information.

19. The web-editing system as claimed in claim 10, wherein the electronic device is a portable electronic device.
